(19) United States
(12) Patent Application Publication
(10) Pub. No.: US 2022/0009510 A1
(43) Pub. Date: Jan. 13, 2022

(54) METHOD FOR TRAINING AT LEAST ONE ALGORITHM FOR A CONTROL DEVICE OF A MOTOR VEHICLE, COMPUTER PROGRAM PRODUCT, AND MOTOR VEHICLE

(71) Applicant: PSA AUTOMOBILES SA, Poissy (FR)

(72) Inventors: Ulrich EBERLE, Rüsselsheim am Main (DE); Sven HALLERBACH, Rüsselsheim am Main (DE); Jakob KAMMERER, Rüsselsheim am Main (DE)

(21) Appl. No.: 17/294,337

(22) PCT Filed: Oct. 24, 2019
(86) PCT No.: PCT/EP2019/078978

§ 371 Date: May 14, 2021

(30) Foreign Application Priority Data
Dec. 3, 2018 (DE) 10 2018 220 865.4

(51) Int. Cl. B60W 50/06; G05B 13/02; B60W 60/00; B60W 40/04

(52) U.S. Cl. CPC B60W 50/06; B60W 40/04; B60W 60/001; G05B 13/027

(57) ABSTRACT

Method for training at least one algorithm for a control device of a motor vehicle for implementing an autonomous driving function, wherein the algorithm is trained by means of a self-learning neural network, comprising the following steps of: a) providing a computer program product module for the autonomous driving function, wherein the computer program product module contains the algorithm to be trained and the self-learning neural network; b) providing at least one metric and a reward function; c) embedding the computer program product module in a simulation environment for simulating at least one relevant traffic situation, and training the self-learning neural network by simulating critical scenarios and determining the metric (M) until a first measure of quality (G1) has been satisfied; d) embedding the trained computer program product module in the control device of the motor vehicle for simulating relevant traffic situations, and training the self-learning neural network by simulating critical scenarios and determining the metric (M) until a second measure of quality has been satisfied, wherein e), (i) when the metric (M) in step d) is worse than the first measure of quality (G1), the method is continued from step c), or, (ii) when the metric (M) in step d) is better than the first measure of quality (G1) and worse than the second measure of quality (G2), the method is continued from step d).

### CROSS-REFERENCE TO RELATED APPLICATIONS

This application is the US National Stage under 35 USC § 371 of International Application No. PCT/EP2019/078978, filed 24 Oct. 2019 which claims priority to German Application No. 10 2018 220 865.4 filed 3 Dec. 2018, both of which are incorporated herein by reference.

### BACKGROUND

Described herein are a method for training at least one algorithm for a control device of a motor vehicle, the control device for implementing an autonomous driving function by intervening in units of the motor vehicle, a computer program product, and a motor vehicle.

Methods, computer program products, and motor vehicles of the above-noted type are known in the prior art. The first autonomously driving vehicles have reached series production maturity in the past few years. Autonomously driving vehicles must react independently to unknown traffic situations with maximum safety based on a variety of specifications, for example destination and compliance with current traffic rules. Since the reality of traffic is highly complex due to the unpredictability of the behavior of road users, it is almost impossible to program corresponding control devices of motor vehicles with conventional methods and rules.

Instead, it is known to use machine learning or artificial intelligence methods to develop algorithms that, on the one hand, can react more moderately to critical traffic situations than traditional algorithms. On the other hand, with the help of artificial intelligence, it is possible to further develop the algorithms in everyday life through continuous learning.

DE 10 2015 007 493 A1 discloses a method for training a decision algorithm based on machine learning used in a control device of a motor vehicle, wherein the decision algorithm, depending on the input data describing the current operating state and/or the current driving situation, determines output data to be taken into account for controlling the operation of the motor vehicle and a reliability value describing the reliability of the output data, and prior to use in the motor vehicle has been trained using a basic training data set, wherein the input data underlying the output data assigned determining the reliability value are stored as assessment input data if the reliability value falls below a threshold value, and at a later point in time are presented to a human assessor, after which assessment output data corresponding to output data are accepted by an operating input of the assessor and the decision algorithm is trained using an improvement training data set formed from the assessment input data and the assigned assessment output data.

Hallerbach, Xia, Eberle & Koester (Apr. 3, 2018), Simulation-based Identification of Critical Scenarios for Cooperative and Automated Vehicles, SAE 2018-01-1066, describes a range of tools for the simulation-based development of critical scenarios. The process includes simulation of the dynamic behavior of motor vehicles as well as simulation of traffic situations and a simulation of cooperative behavior of virtual road users. Critical situations are recognized using metrics, e.g. safety metrics or traffic quality metrics.

The disadvantage of the known methods is that the development of series-ready algorithms for autonomously driving motor vehicles is complex and takes a very long time.

### SUMMARY

Thus, the object arises of further developing methods for training at least one algorithm for a control device of a motor vehicle, computer program products, and motor vehicles of the aforesaid type so that autonomous driving functions can be implemented in autonomous motor vehicles faster and with higher quality than before.

The object is achieved using a method for training at least one algorithm for a control device of a motor vehicle according to Claim 1, a computer program product according to ancillary Claim 9, and a motor vehicle according to ancillary Claim 11. Further embodiments and refinements are the subject matter of the dependent claims.

A method for training at least one algorithm for a control device of a motor vehicle is described below, wherein the control device is provided for implementing an autonomous driving function by intervening in units of the motor vehicle on the basis of input data using the at least one algorithm, wherein the algorithm is trained using a self-learning neural network, comprising the following steps:
a) Providing a computer program product module for the autonomous driving function, wherein the computer program product module contains the algorithm to be trained and the self-learning neural network;
b) Providing at least one metric and a reward function for the autonomous driving function;
c) Embedding the computer program product module in a simulation environment for simulating at least one traffic situation relevant to the autonomous driving function, wherein the simulation environment is based on map data of a real environment and on a digital vehicle model of the motor vehicle, and training the self-learning neural network by simulating critical scenarios and determining a quality, the quality being a result of a quality function of the at least one metric, until a first measure of quality has been satisfied;
d) Embedding the trained computer program product module in the control device of the motor vehicle for simulating traffic situations relevant to the autonomous driving function, the simulation being carried out in a simulation environment on map data from the real environment, and training the self-learning neural network by simulating critical scenarios and determining a quality until a second measure of quality has been satisfied, the second measure of quality being stricter than the first measure of quality, wherein
e) (i) when the quality in step d) is worse than the first measure of quality, the method is continued from step c), or,
   (ii) when the quality in step d) is better than the first measure of quality and worse than the second measure of quality, the method is continued from step d).

Using the method described above, an algorithm for implementing an autonomous driving function, which algorithm develops through a self-learning neural network, can be developed faster and more safely than with conventional methods.

Because the system is trained in a purely virtual environment in an early step, the algorithm can already reach a certain level of maturity before the self-learning neural network in a next step can adapt the algorithm to a more complex situation in a safe virtual environment using the real motor vehicle. The increased complexity results, for example, from the variance of sensor input signals from real sensors, delays in the signal chain, temperature dependencies, and similar phenomena.

By introducing the measure of quality for the algorithm against which the determined metric is measured, if the algorithm is unsuitable in the higher reality level in step d), a long learning process can be avoided in that the learning process is first returned to the less complex full simulation in step c) and the algorithm is further developed there.

For example, corresponding metrics can be the average number of accidents per segment, the number of hazardous situations per segment, the number of incidents of non-compliance with traffic rules per segment, etc. A quality can be determined from the metrics and can be measured against measures of quality. Stricter measures of quality then denote, for example, fewer accidents per segment, fewer hazardous situations per segment, etc. The training can be continued in the next level only when the measures of quality are no longer unsatisfied. This can prevent unstable algorithms from requiring long learning times and a higher quality algorithm can be achieved earlier.

A first possible further embodiment provides that:
f) a simulation of traffic situations relevant for the autonomous driving function is carried out in a mixed-real environment and self-learning neural network is trained by simulating critical scenarios and the quality is determined until a third measure of quality has been satisfied, the third measure of quality being stricter than the second measure of quality, wherein
g) when the quality in step f) is worse than the second measure of quality, the method is continued from step e).

According to this embodiment, in a next step the algorithm can be further developed using the self-learning neural network in a mixed-real environment in which the risk to road users is minimized. The learning process can also be accelerated by checking the quality using the measure of quality and, if necessary, returning to an earlier stage of the development of the algorithm.

Another possible further embodiment provides that:
h) a simulation of traffic situations relevant for the autonomous driving function is carried out in a real environment and the self-learning neural network is trained by simulating critical scenarios and the quality is determined until a fourth measure of quality has been satisfied, the fourth measure of quality being stricter than the third measure of quality, wherein
i) when the quality in step h) is worse than the third measure of quality, the method is continued from step g), or when the quality in step h) is worse than the second measure of quality, the method is continued from step e).

According to this embodiment, in a next step the algorithm can be further developed in a real environment using the self-learning neural network. At this point in time, it can be assumed that the algorithm is already stable enough that road safety is no longer endangered. The learning process can also be accelerated by checking the qualities and, if necessary, returning to an earlier step in the development of the algorithm.

Another possible further refinement provides that the computer program product module is released for use in street traffic when the metric satisfies the fourth measure of quality.

At this point in time, it can be assumed that the algorithm is stable enough to be used in regular street traffic.

Another possible further refinement provides that method steps f) and/or h) are carried out by safety drivers.

This can further reduce the risk for other road users, since the safety drivers are instructed to always take control of the autonomously driving motor vehicle at short notice.

Another possible further refinement provides that the metric has a measure of accidents-per-distance unit and/or time-to-collision and/or time-to-braking and/or required deceleration.

Corresponding metrics are easy to determine.

Another possible further refinement provides that the neural network learns according to the “reinforcement learning” method.

Reinforcement learning denotes a number of machine learning methods in which an agent, in this case the self-learning neural network, continuously learns a strategy itself in order to maximize the rewards received. The agent is not shown which action is best in which situation, but instead at certain times receives a reward, which can also be negative. On the basis of the rewards, the agent approximates a utility function that describes the value of a certain state or a certain action. Using the appropriate learning methods, the self-learning neural network can continuously develop the algorithm further.

Another possible further refinement provides that the neural network tries out variations of the existing algorithm according to the random principle.

In this way it can be achieved that various strategies that lead to the desired result are tested in the high-dimensional space in which the algorithm is used.

A first independent subject matter relates to a device for training at least one algorithm for a control device of a motor vehicle, wherein the control device is provided for implementing an autonomous driving function by intervening in units of the motor vehicle on the basis of input data using the at least one algorithm, the algorithm being trained by a self-learning neural network, the device being set up to carry out the following steps:
a) Providing a computer program product module for the autonomous driving function, wherein the computer program product module contains the algorithm to be trained and the self-learning neural network;
b) Providing at least one metric and a reward function for the autonomous driving function;
c) Embedding the computer program product module in a simulation environment for simulating at least one traffic situation relevant to the autonomous driving function, wherein the simulation environment is based on map data of a real environment and on a digital vehicle model of the motor vehicle, and training the self-learning neural network by simulating critical scenarios and determining a quality, the quality being a result of a quality function of the at least one metric, until a first measure of quality has been satisfied;
d) Embedding the trained computer program product module in the control device of the motor vehicle for simulating traffic situations relevant to the autonomous driving function, the simulation being carried out in a simulation environment on map data from the real environment, and training the self-learning neural network by simulating critical scenarios and determining the metric until a second measure of quality has been satisfied, wherein the second measure of quality is stricter than the first measure of quality, wherein
(i) when the quality in step d) is worse than the first measure of quality, the method is continued from step c), or,
(ii) when the quality in step d) is better than the first measure of quality and worse than the second measure of quality, the method is continued from step d).

A first possible further refinement provides that the device is also set up such that:
a) simulation of traffic situations relevant for the autonomous driving function is carried out in a mixed-real environment and self-learning neural network is trained by simulating critical scenarios and the quality is determined until a third measure of quality has been satisfied, wherein the third measure of quality is stricter than the second measure of quality, wherein
b) when the quality in step f) is worse than the second measure of quality, the method is continued from step e).

Another possible further refinement provides that the device is also set up such that:
a) a simulation of traffic situations relevant for the autonomous driving function is carried out in a real environment and the self-learning neural network is trained by simulating critical scenarios and the quality is determined until a fourth measure of quality has been satisfied, wherein the fourth measure of quality is stricter than the third measure of quality, wherein, when the quality in step h) is worse than the third measure of quality, the method is continued from step g), or when the quality in step h) is worse than the second measure of quality, the method is continued from step e).

Another possible further refinement provides that the device is also set up such that the computer program product module is released for use in street traffic when the quality has satisfied the fourth measure of quality.

Another possible further refinement provides that the device is set up such that method steps f) and/or h) can be carried out by safety drivers.

Another possible further refinement provides that the device is set up to use a measure of accidents-per-distance unit and/or time-to-collision and/or time-to-braking and/or required deceleration as the metric.

Another possible further refinement provides that the neural network is set up to learn according to the “reinforcement learning” method.

Another possible further refinement provides that the neural network is set up to try out variations in the existing algorithm according to the random principle.

Another independent subject matter relates to a computer program product with a computer-readable storage medium on which are embedded instructions which, when executed by a computing unit, cause the computing unit to be set up to carry out the method according to one of the preceding claims.

A first further refinement of the computer program product provides that the computer program product module of the type described above has the instructions.

Another independent subject matter relates to a motor vehicle with a computing unit and a computer-readable storage medium, wherein a computer program product of the type described in the foregoing is stored on the storage medium.

A first further refinement provides that the computing unit is a component of the control device.

Another further refinement provides that the computing unit is connected to environmental sensors.

### DESCRIPTION OF THE FIGURES

Further features and details emerge from the following description, in which at least one exemplary embodiment is described in detail, sometimes referencing the drawings. Described and/or graphically represented features form the subject matter individually or in any meaningful combination, possibly also independently of the claims, and can in particular also be the subject matter of one or more separate applications. Identical, similar, and/or functionally identical parts are provided with the same reference symbols. They show schematically:

FIG. 1 is a schematic drawing of a motor vehicle that is set up for autonomous driving;

FIG. 2 is a schematic diagram of a computer program product for the motor vehicle from FIG. 1, and,

FIG. 3 is a flow chart for the method.

### DETAILED DESCRIPTION

FIG. 1 depicts a motor vehicle 2 which is set up for autonomous driving.

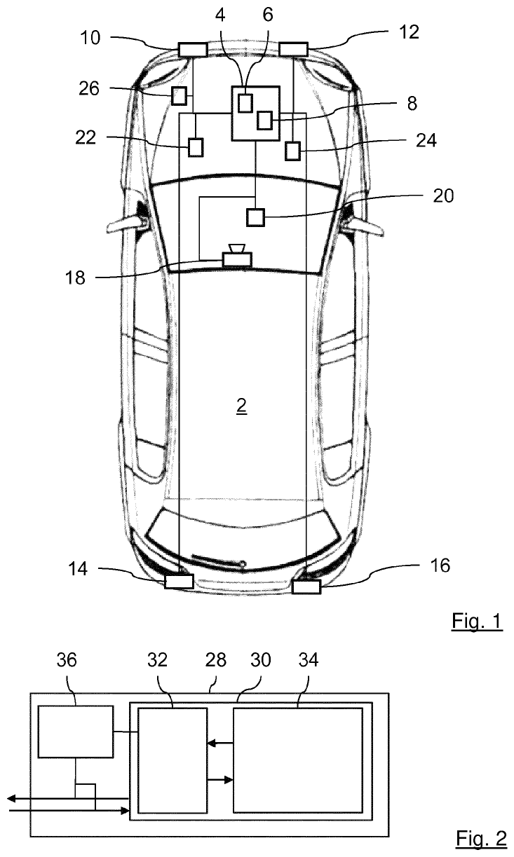

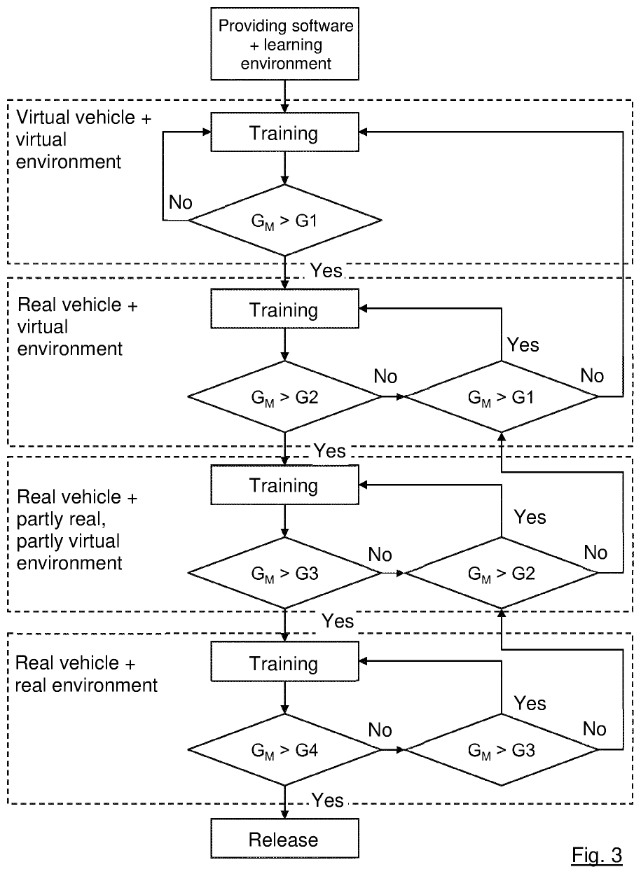

The motor vehicle 2 has a motor vehicle control device 4 with a computing unit 6 and a memory 8. A computer program product is stored in the memory 8 and is described in more detail below, in particular in connection with FIG. 2 and FIG. 3.

The motor vehicle control device 4 is connected, on the one hand, to a series of environmental sensors which allow the current position of the motor vehicle 2 and the respective traffic situation to be recorded. These include environmental sensors 10, 12 at the front of the motor vehicle 2, environmental sensors 14, 16 at the rear of the motor vehicle 2, a camera 18, and a GPS module 20. Depending on the configuration, further sensors can be provided, for example wheel speed sensors, acceleration sensors, etc., which are connected to the motor vehicle control device 4.

During the operation of the motor vehicle 2, the computing unit 6 has loaded the computer program product stored in the memory 8 and executes it. Based on an algorithm and the input signals, the computing unit 6 decides on the control of the motor vehicle 2, which control the computing unit 6 can achieve by intervening in the steering 22, engine control 24, and brakes 26, which are each connected to the motor vehicle control device 4.

FIG. 2 depicts a computer program product 28 with a computer program product module 30.

The computer program product 30 has a self-learning neural network 32 that trains an algorithm 34. The self-learning neural network 32 learns according to methods of reinforcement learning, i.e. the neural network 32 tries to obtain rewards for improved behavior according to one or more criteria or measures, that is, for improvements in the algorithm 34, by varying the algorithm 34.

The algorithm 34 can essentially comprise a complex filter with a matrix of values, often called weights, that define a filter function that determines the behavior of the algorithm 34 as a function of input variables that are presently received via the environmental sensors 10 to 20, and generates control signals for controlling the motor vehicle 2.

The quality of the algorithm 34 is monitored by a further computer program product module 36, which monitors input variables and output variables, determines metrics therefrom, and controls compliance with the quality through the functions using the metrics. At the same time, the computer program product module 36 can give negative as well as positive rewards for the neural network 32.

FIG. 3 depicts a flow chart for the method.

The computer program product module and a learning environment are provided in a first step.

In a purely virtual environment, both the motor vehicle, as a model, and the environment are provided virtually. The model of the motor vehicle corresponds to the later real model in terms of its parameters, sensors, driving characteristics, and behavior. The model of the environment is based on map data of a real environment in order to make the model as realistic as possible.

Training takes place in this purely virtual environment until a quality G_{M} is better than a predetermined measure of quality G1. The quality G_{M} results from a quality function G(M), which is a function of at least one metric M. A corresponding metric M can be a measure such as accidents-per-distance unit and/or time-to-collision and/or time-to-braking and/or have similar measured variables, for example required decelerations, lateral acceleration, maintaining safety distances, violations of applicable traffic rules, etc.

The training is continued as long as the quality G_{M} is not sufficient to exceed the first measure of quality G1.

Only when the quality G_{M} is so high that the first measure of quality G1 is exceeded is there a shift to the next phase of training, in which the computer program product is transmitted to the motor vehicle control device 4 of a real motor vehicle and training is continued there.

The training takes place using a real motor vehicle in a virtual environment. By using a real motor vehicle that may behave differently than its virtual model from the first training segment, the algorithm 34 can be further developed such that it can take into account the behavior of the real motor vehicle 2. Differences can arise, for example, through the use of real sensors, which can have different signal levels, noise, etc.

The quality function G(M) is always monitored during training. The goal is for the quality G_{M} to be better than a second measure of quality G2. The second measure of quality G2 is stricter than the first measure of quality G1.

When changing to the real motor vehicle 2, it can happen that the quality G_{M} falls short of the first measure of quality G1. In this case, there is a switch back to the purely virtual environment and the training is continued until the algorithm 34 exceeds the first measure of quality G1 and the training with the real motor vehicle 2 is continued.

Training cannot be continued in the next step until the quality G_{M} no longer falls short of the second measure of quality G2.

Then a shift is made to a partly real, partly virtual environment in which the previously described principle is continued. If the quality function falls short of the threshold value of the second measure of quality G2, the method is reset to the previous training step. If the quality function even falls short of the threshold value of the first measure of quality G1, the method is returned to the initial training step.

The same principle is continued in the next step in that the neural network is trained in a real environment. This and the previous step can be carried out using safety drivers who can quickly switch back to a manual driving mode in critical situations.

As soon as a quality G_{M} better than the fourth G4, the algorithm 34 can be released for free traffic.

Although the subject matter was illustrated and explained in greater detail using embodiments, the invention is not limited to the disclosed examples and other variations can be derived from them by the person skilled in the art. It is therefore clear that there is a plurality of possible variations. It is also clear that embodiments cited by way of example only represent examples that are not to be interpreted in any way as a limitation, for example, of the scope of protection, the possible applications, or the configuration of the invention. Instead, the preceding description and the description of the figures enable the person skilled in the art to actually implement the exemplary embodiments, wherein the person skilled in the art can make various changes with knowledge of the disclosed inventive concept, for example with regard to the function or the arrangement of individual elements mentioned in an exemplary embodiment, without departing from the scope of protection which is defined by the claims and their legal equivalents, such as further explanations in the description.

### LIST OF REFERENCE SYMBOLS

2 Motor vehicle

4 Motor vehicle control device

6 Computing unit

8 Memory

10 Environmental sensor

12 Environmental sensor

14 Environmental sensor

16 Environmental sensor

18 Camera

20 GPS module

22 Steering

24 Engine control

26 Brake

28 Computer program product

30 Computer program product module

32 Neural network

34 Algorithm

36 Computer program product module

G(M) Quality function

G_{M} Quality

G1 First measure of quality

G2 Second measure of quality

G3 Third measure of quality

G4 Fourth measure of quality

M Metric

1. A method for training at least one algorithm for a control device of a motor vehicle, wherein the control device is provided for implementing an autonomous driving function by intervening in units of the motor vehicle on the basis of input data using the at least one algorithm, wherein the algorithm is trained by a self-learning neural network, comprising the following steps:
a) Providing a computer program product module for the autonomous driving function, wherein the computer program product module contains the algorithm to be trained and the self-learning neural network;
b) Providing at least one metric (M) and a reward function for the autonomous driving function;
c) Embedding the computer program product module in a simulation environment for simulating at least one traffic situation relevant to the autonomous driving function, wherein the simulation environment is based on map data of a real environment and on a digital vehicle model of the motor vehicle, and training the self-learning neural network by simulating critical scenarios and determining a quality (G_{M}), the quality (GM) being a result of a quality function (G(M)) of the at least one metric (M), until a first measure of quality (G1) has been satisfied;
d) Embedding the trained computer program product module in the control device of the motor vehicle for simulating traffic situations relevant to the autonomous driving function, the simulation being carried out in a simulation environment on map data of a real environment, and training the self-learning neural network by simulating critical scenarios and determining the quality (G_{M}) until a second measure of quality (G2) has been satisfied, the second measure of quality (G2) being stricter than the first measure of quality (G1), wherein
e) (i) when the quality (G_{M}) in step d) is worse than the first measure of quality (G1), the method is continued from step c), or,
(ii) when the quality (G_{M}) in step d) is better than the first measure of quality (G1) and worse than the second measure of quality (G2), the method is continued from step d).

2. The method according to claim 1, wherein
f) a simulation of traffic situations relevant for the autonomous driving function is carried out in a mixed-real environment and the self-learning neural network is trained by simulating critical scenarios and the quality (G_{M}) is determined until a third measure of quality (G3) has been satisfied, the third measure of quality (G3) being stricter than the second measure of quality (G2), wherein
g) when the quality (G_{M}) in step f) is worse than the second measure of quality (G2), the method is continued from step e).

3. The method according to claim 2, wherein
h) a simulation of traffic situations relevant for the autonomous driving function is carried out in a real environment and the self-learning neural network is trained by simulating critical scenarios and the quality (G_{M}) is determined until a fourth measure of quality (G4) has been satisfied, the fourth measure of quality (G4) being stricter than the third measure of quality (G3), wherein
i) when the quality (GM) in step h) is worse than the third measure of quality (G3), the method is continued from step g), or when the quality (G_{M}) in step h) is worse than the second measure of quality (G2), the method is continued from step e).

4. The method according to claim 3, wherein when the quality (GM) has satisfied the fourth measure of quality (G4), the computer program product module is released for use in street traffic.

5. The method according to claim 3, wherein method steps f) and/or h) are carried out by safety drivers.

6. The method according to claim 1, wherein the metric (M) comprises a measure of accidents-per-distance unit and/or time-to-collision and/or time-to-braking and/or required deceleration.

7. The method according to claim 1, wherein the neural network learns according to the “reinforcement learning” method.

8. The method according to claim 1, wherein the neural network tries out variations of the existing algorithm according to the random principle.

9. A computer program product with a computer-readable storage medium on which are embedded instructions which, when executed by a computing unit, cause the computing unit to be set up to carry out the method according to claim 1.

10. The computer program product according to claim 9, wherein the computer program product module has the instructions according to claim 1.

11. A motor vehicle with a computing unit and a computer-readable storage medium, wherein a computer program product according to claim 9 is stored on the storage medium.

12. The motor vehicle according to claim 11, wherein the computing unit is a component of the control device.

13. The motor vehicle according to claim 11, wherein the computing unit is connected to environmental sensors.
